(19) United States
(12) Patent Application Publication
(10) Pub. No.: US 2016/0240977 A1
(43) Pub. Date: Aug. 18, 2016

(54) ELECTRICAL CONNECTOR AND METHOD OF MAKING THE SAME

(71) Applicant: ALLTOP ELECTRONICS (SUZHOU) LTD., Taicang City (CN)

(72) Inventors: Wang-I YU, JHONGHE City (TW); Yi-Chang CHEN, JHONGHE City (TW); Mao-Jung HUANG, JHONGHE City (TW)

(73) Assignee: ALLTOP ELECTRONICS (SUZHOU) LTD., Taicang City (CN)

(21) Appl. No.: 14/737,660

(22) Filed: Jun. 12, 2015

(30) Foreign Application Priority Data
Feb. 15, 2015 (CN) 201510082933.4

(51) Int. Cl. H01R 13/6471; H01R 13/66; H01R 13/6585; H01R 43/20

(52) U.S. Cl. CPC H01R 13/6471; H01R 43/205; H01R 13/665; H01R 13/6585

(57) ABSTRACT

The present invention relates to an electrical connector and method of making the same. The electrical connector includes an insulative housing, an internal circuit board extending from the front side of the insulative housing, a contact module received in the insulative housing and connected with the internal circuit board, and a shell covering the insulative housing and the internal circuit board. The shell and the internal circuit board form a mating space therebetween. The mating space is used to receive a mating plug.

### BACKGROUND OF THE INVENTION

1. Field of the Invention

The present invention relates to an electrical connector and method of making the same, and more particularly to an electrical connector is easy to fabricate.

2. Description of Related Art

In the end of 2008, USB Implementers Forum (USB-IF) released USB 3.0 specification. The USB 3.0 electrical connector adds two pair of differential contacts and a grounding contact to the USB 2.0 for increasing the speed rate up to 5 GB/s and is backward compatible with USB 2.0. With the development of electronic industry, USB 3.0 can't meet the requirements of consumer. Thus, USB-IF announced USB Type-C connectors which is reversible so that it can be used in any orientation. Moreover, it gets faster and EMI of which is improved. However, USB C-type connector is complicated and challenges the manufacturing and the assembling ability.

Hence, it is desired to provide an electrical connector to overcome the problems mentioned above.

### BRIEF SUMMARY OF THE INVENTION

Accordingly, an object of the present invention is to provide an electrical connector which facilitates to manufacture and has improved transmitting speed.

The present invention is directed to an electrical connector comprises an insulative housing having a front portion and a rear portion, an internal circuit board attached to the insulative housing and projecting forwardly from the insulative housing, a contact module attached to the insulative housing and having a plurality of electrical contacts connected with the internal circuit board, and a shell surrounding the insulative housing and the internal circuit board. The shell and the internal circuit board define a receiving space for accommodating a mating plug.

The present invention is directed to a method for making an electrical connector, comprises the steps of providing a plurality of electrical contacts each having a connecting section and a solder tail. Provide a base to secure the electrical contacts and form a contact module with the connect section and the solder tail extending out of the base. Provide an internal circuit board having a plurality of first golden fingers exposed at a front end thereof and a plurality of conductive traces corresponding to the first golden fingers. The first golden fingers and the conductive traces form a plurality of electrical circuits. Connect the connecting section with the electrical circuits respectively. Provide an insulative housing surrounding a rear end of the internal circuit board and the contact module. Provide a metal shell surrounding to the insulative housing and the internal circuit board to form a receiving space for accommodating a plug.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector according to the present invention;

FIG. 2 is an exploded view of the electrical connector shown in FIG. 1;

FIG. 3 is similar to FIG. 2 but viewed from another aspect;

FIG. 4 is an exploded view of the contact module and the internal circuit board shown in FIG. 2;

FIG. 5 is an exploded view of the internal circuit board;

FIG. 6 is an assembled view of the contact module and the internal circuit board according to a second embodiment of the present invention;

FIG. 7 is an exploded view of FIG. 6;

FIG. 8 is similar to FIG. 7 but viewed from a different aspect; and

FIG. 9 is an exploded view of the internal circuit board shown in FIG. 6.

### DETAILED DESCRIPTION OF THE PREFERRED EMBODIMENT

Reference will be made to the drawing figures to describe the present invention in detail, wherein depicted elements are not necessarily shown to scale and wherein like of similar elements are designated by same or similar reference numeral through the several views and same or similar terminology.

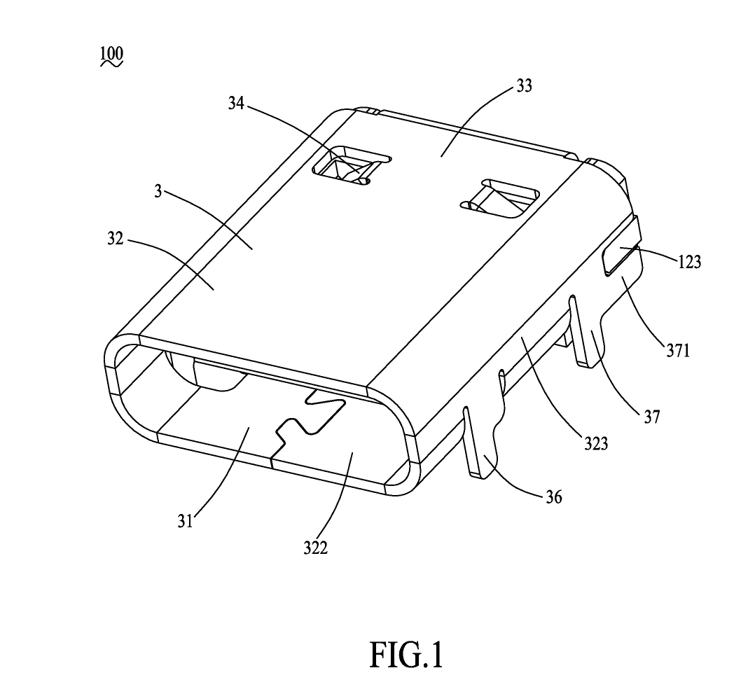

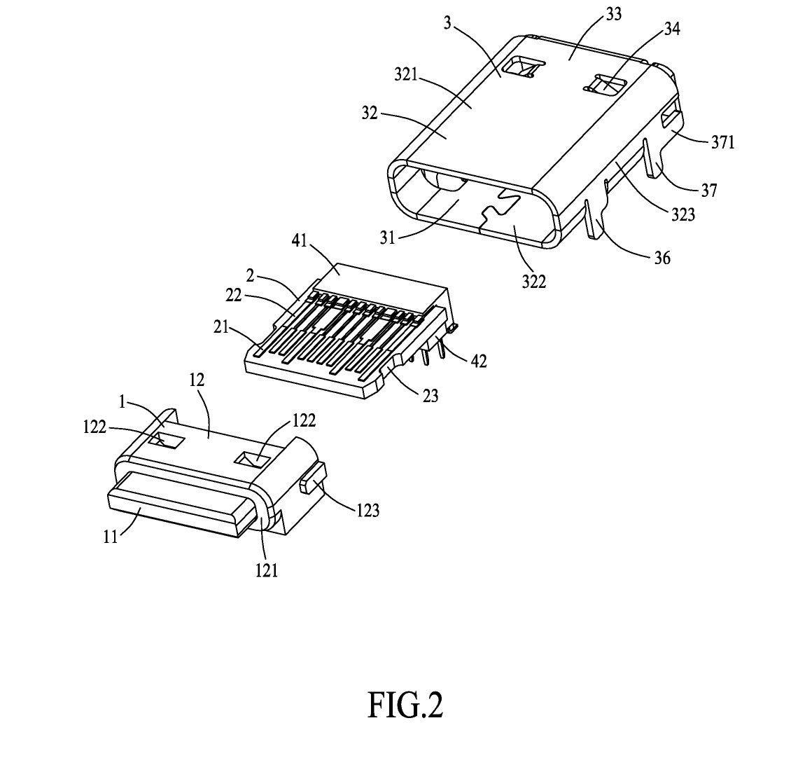

Please referring to FIG. 1 and FIG. 2, the present invention is directed to an electrical connector 100 mounting to a mother board (not shown) for mating with a plug (not shown). The electrical connector 100 includes an insulative housing 1, an internal circuit board 2 and a contact module secured to the insulative housing 1, and a metal shell 3 surrounding the insulative housing 1 and the internal circuit board 2.

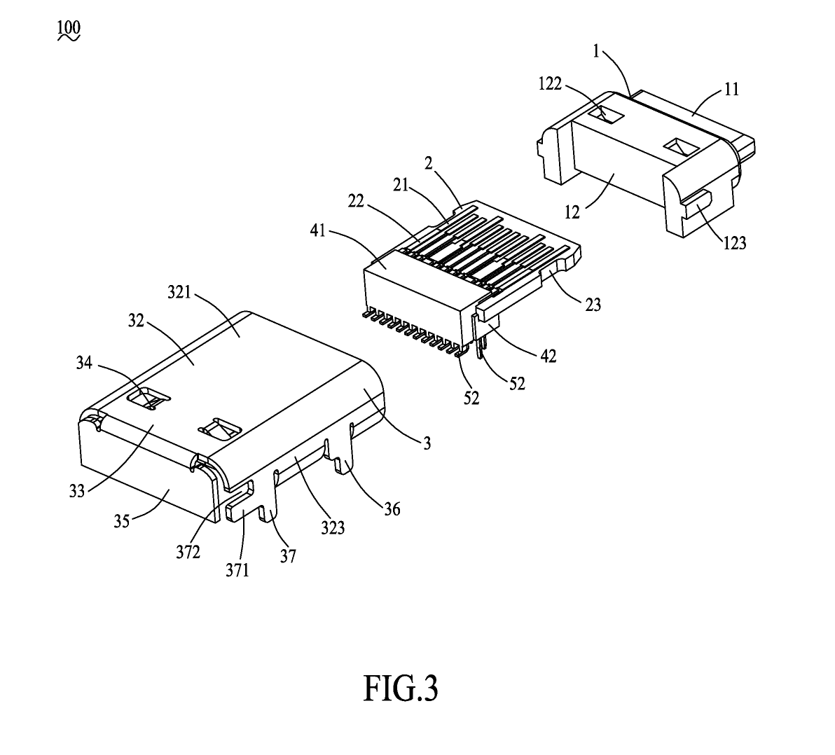

Please referring to FIG. 2 and FIG. 3, the insulative housing 1 has a front portion 11 surrounding part of the internal circuit board 2 and a rear portion 12 surrounding the contact module. The front portion 11 protrudes from the rear portion 12 thereby forms a stopping face 121 on the rear portion 12 for abutting against the plug. The rear portion 12 defines a pair of recesses 122 on a top thereof and a pair of protrusions 123 at opposite sides thereof.

The shell 3 and the internal circuit board 2 form a receiving space 31 for accommodating the mating plug. The shell 3 includes a front portion 32 surrounding the insulative housing 1 and the internal circuit board 2, and a rear portion 33 shielding a rear end of the insulative housing 1 and the contact module. The front portion 32 has a top wall 321, a bottom wall 322, and a pair of sidewalls 323 connected with the top wall 321 and the bottom wall 322.

The rear portion 33 has a plurality of spring tabs 34 projecting into the recesses 122 for securing the shell 3 to the insulative housing 1. The front portion 32 is provided with a pair of first tails 36 torn from the bottom wall 322 and bending downwardly from the sidewalls 323. The rear portion 33 includes a pair of second tails 37 projecting downwardly, an extending arm 371 perpendicular to the second tails 37 and a rear wall 35 bending from the top wall 321. The first and second tails 36, 37 are soldered to the mother board. The rear portion 33 forms a pair of notches 372 adjacent to the extending arm 371 and corresponding to the protrusions 123.

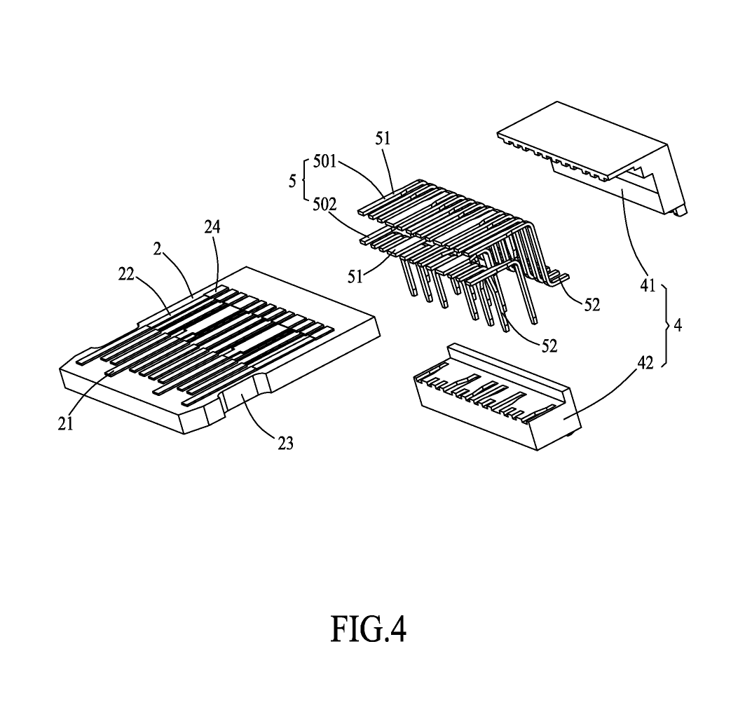

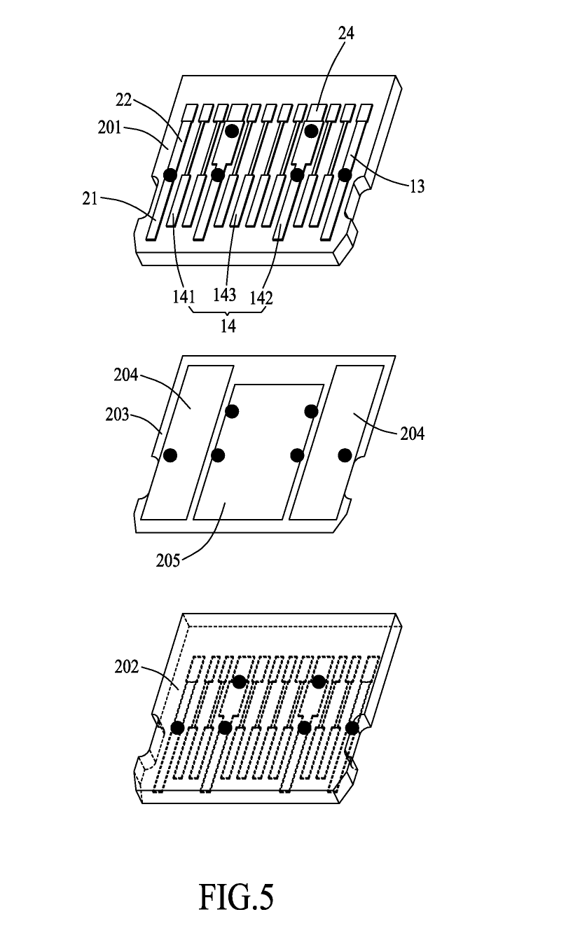

Referring to FIGS. 4 and 5, the internal circuit board 2 is secured to the front portion 11 of the insulative housing 1 and includes a plurality of first golden fingers 21 at a front end thereof, a plurality of second golden fingers 24 at a rear end thereof and a plurality of conductive traces 22 connected with the first and second golden fingers 21, 24. The conductive traces 22 are coated with insulation paint for preventing the plug from directly contacting with the conductive traces 22. The second golden fingers 24 are connected with a plurality of electrical contacts 5 of the contact module thereby form a plurality of electrical circuits.

The configuration of the electrical connector 100 conforms to USB Type-C and the first and second golden fingers 21, 24 and the conductive traces 22 are arranged on both top and bottom surface of the internal circuit board 2. A pair of notches 23 is provided on opposite sides of the internal circuit board 2.

The present invention is provided with an internal circuit board 1 which facilitates to manufacture and has improved transmitting speed. The internal circuit board 2 has a top layer 201, a bottom layer 202, and a middle layer 203. The first and second golden fingers 21, 24 and the conductive traces 22 are disposed on the top and bottom layers 201, 202. Each of the top layer 201 and the bottom layer 202 include two grounding circuits 13 at outermost sides and a plurality of signal circuits 14 located therebetween. The signal circuits 14 includes two pair of high frequency signal circuits 141 adjacent to the grounding circuits 13 respectively, two power circuits 142 at inner side of the high frequency signal circuits 141 and four low frequency signal circuits 143 located between the two power circuits 142. The electrical circuits on the top layer 201 and the bottom layer 202 are similar but disposed in opposite directions.

The middle layer 203 has two grounding copper foils 204 at opposite sides thereof and a middle copper foil 205 located between the grounding copper foils 204. The grounding copper foils 204 are sandwiched by the high frequency signal circuits 141 and the grounding circuits 13 of the top layer 201 and the bottom layer 202 thereby preventing crosstalk between the top layer 201 and the bottom layer 202. Furthermore, the grounding circuits 13 of the top and bottom layers 201, 202 contact with a plurality of plated-through holes (not labeled) of the grounding copper foils 204 to establish a grounding path and improve shielding. The grounding copper foils 204 extend into the notches 23 so as to contact with grounding tabs (not shown) of the plug.

The middle copper layer 205 is sandwiched by the power circuits 142 of the top layer 201 and the bottom layer 202. The middle copper layer 205 contacts with the power circuits 142 respectively via plated-through holes (not labeled) thereby form two parallel power paths between the top and bottom layers 201, 202 and decrease the resistance for transmitting biggish current.

Please further refer to FIG. 4, the contact module includes a base 4 and a plurality of electrical contacts 5 retained in the base 4. The electrical contacts 5 are arranged in two groups named first contacts 501 and second contacts 502 for contacting with the top layer 201 and the bottom layer 202 respectively. Each of the contacts 5 has a connecting section 51 connecting with the second golden fingers 24 and a solder tail 52 extending out of the base 5 and soldered to the mother board.

Please further refer to FIG. 4, the base 4 has an upper part 41 and a lower part 42 assembled together. The first contacts 501 are insert-molding with the upper art 41 and the second contacts 502 are insert-molding with the lower part 42.

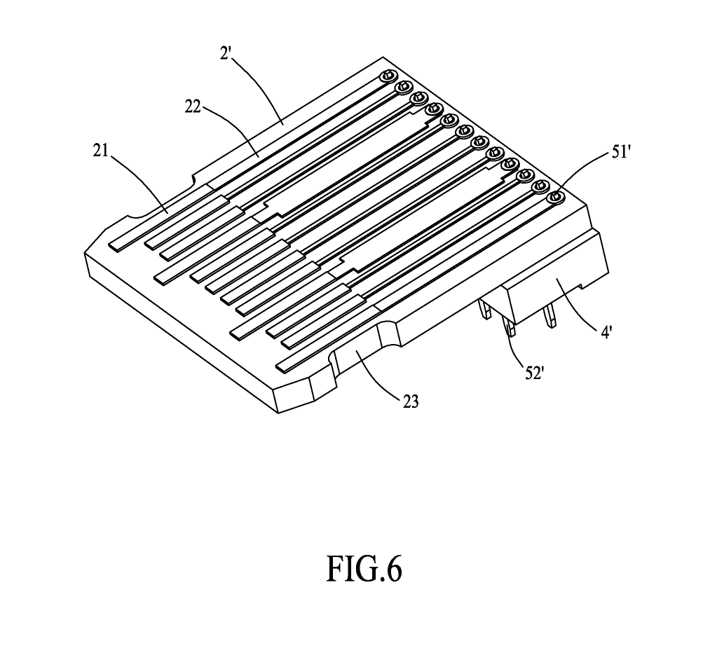

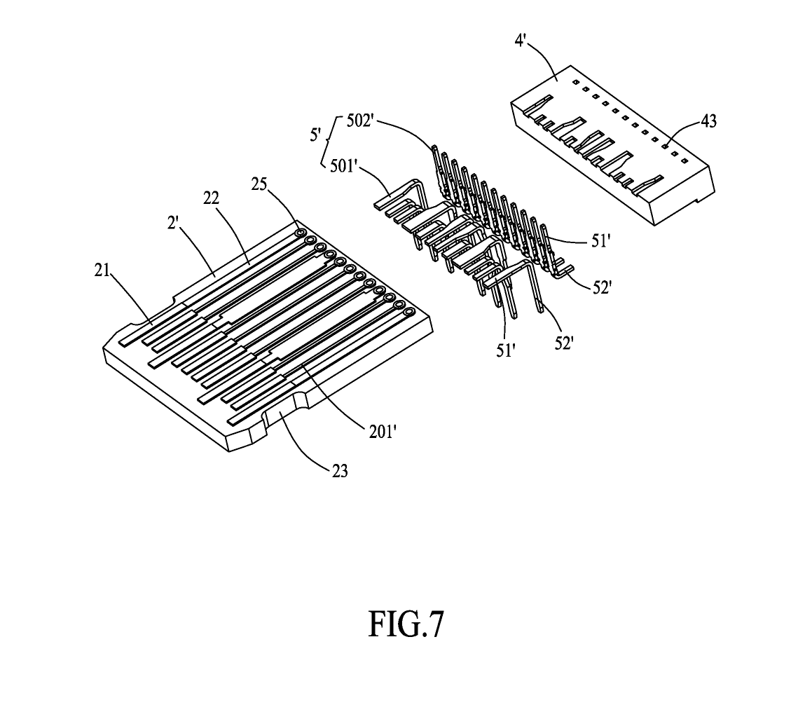

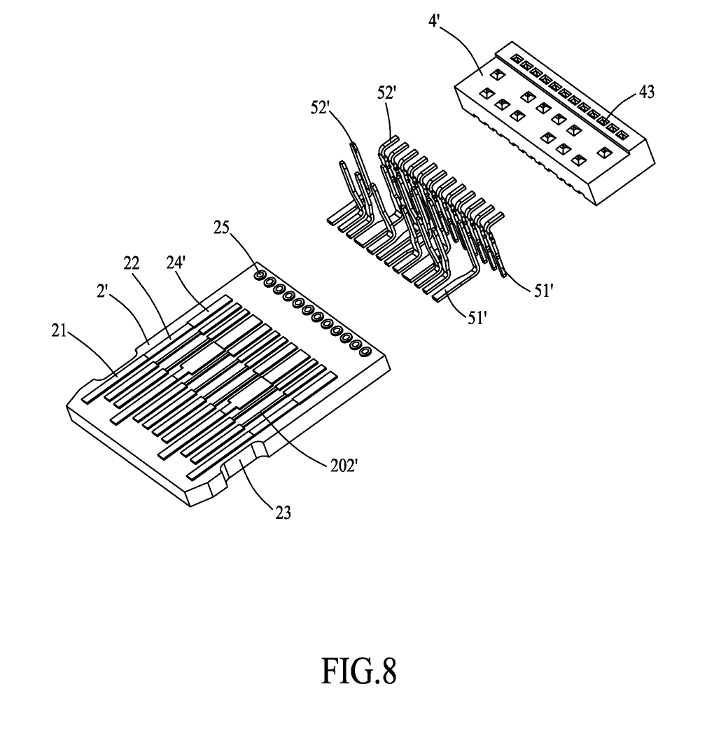

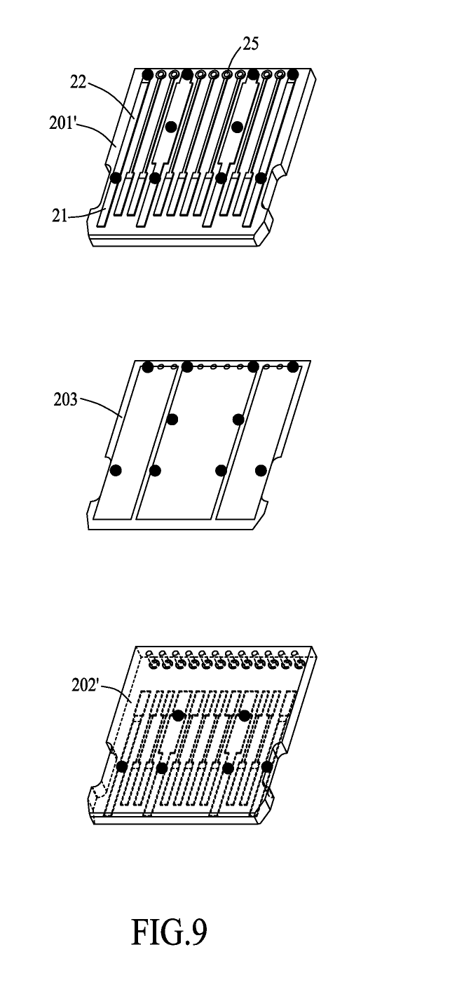

FIGS. 6-9 illustrate an internal circuit board 2′ according to a second embodiment of the present invention. The electrical contacts 5′ include a plurality of first contacts 501′ and second contacts 502′. The internal circuit board 2′ is provided a plurality of golden fingers 24′ on a bottom layer 202′ thereof for contacting with the second contacts 502′. A plurality of soldering holes 25 extend through the internal circuit board 2′ for electrically connecting with the first contacts 501′.

The first contacts 501′ are insert-molding with a base 4′ and connecting sections 51′ thereof are connected with the second golden fingers 24′. The base 4′ defines a plurality of passageways 43 for receiving the second contacts 502′. Connecting sections 51′ of the second contacts 502′ project into the soldering holes 25 and electrically connect with the soldering holes 25. Solder tails 52′ of the first contacts 501′ extend out of the base 4′ for soldering to the mother board. Solder tails 52′ of the second contacts 502′ are soldered to the mother board by SMT.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector for mounting to a mother board and mating with a plug, comprising:
an insulative housing having a front portion and a rear portion;
an internal circuit board attached to the insulative housing and projecting forwardly from the insulative housing;
a contact module attached to the insulative housing and having a plurality of electrical contacts connected with the internal circuit board; and
a shell surrounding the insulative housing and the internal circuit board, the shell and the internal circuit board defining a receiving space for accommodating the plug.

2. The electrical connector as claimed in claim 1, wherein the contact module has a base and the electrical contact are secured to the base, and wherein each of the electrical contact has a connecting section electrically connected with the internal circuit board and a soldering tail extending out of the base for soldering to the mother board.

3. The electrical connector as claimed in claim 1, wherein the front portion protrudes from the rear portion thereby forms a stopping face on the rear portion.

4. The electrical connector as claimed in claim 2, wherein the internal circuit board is provided with a plurality of first golden fingers exposing to the top and bottom surfaces thereof and a plurality of conductive traces corresponding to the first golden fingers respectively thereby forming a plurality of electrical circuits; and wherein the electrical contacts include two groups for connecting with the electrical circuits of the top and bottom surfaces.

5. The electrical connector as claimed in claim 4, wherein the internal circuit board has a plurality of second golden fingers at a rear end thereof and connecting with the conductive traces, and wherein the connecting section of the electrical contacts are electrically connected with the second golden fingers.

6. The electrical connector as claimed in claim 4, wherein the internal circuit board has a plurality of soldering holes at a rear end thereof and connecting with the conductive traces, and wherein the connecting section of the electrical contacts are electrically connected with the soldering holes.

7. The electrical connector as claimed in claim 4, wherein the base has an upper part and a lower part assembled together and wherein a group of the electrical contacts are insert-molding with the upper art and the other group of the electrical contacts are insert-molding with the lower part.

8. The electrical connector as claimed in claim 5, wherein the internal circuit board has a top layer, a bottom layer, and a middle layer, and wherein the first and second golden fingers and the conductive traces are disposed on the top and bottom layers.

9. The electrical connector as claimed in claim 8, wherein the electrical circuits on the bottom layer or the top layer each include two grounding circuits at outermost sides and a plurality of signal circuits located therebetween, and wherein the signal circuits on each layer includes two pair of high frequency signal circuits adjacent to the grounding circuits respectively, two power circuits at inner side of the high frequency signal circuits and four low frequency signal circuits located between the two power circuits, and wherein the electrical circuits on the top layer and the bottom layer are similar but disposed in opposite directions.

10. The electrical connector as claimed in claim 9, wherein the middle layer has two grounding copper foils at opposite sides thereof and a middle copper foil located between the grounding copper foils; and wherein the grounding circuits of the top and bottom layers contact with plated-through holes defined on the grounding copper foils to establish a grounding path; and wherein the power circuits of the top and bottom layers electrically connect with each other by the middle copper foil.

11. The electrical connector as claimed in claim 10, wherein the grounding copper foils extend into a pair of notches defined on opposite sides of the internal circuit board for contacting with grounding tabs of the plug.

12. A method for making an electrical connector, comprising the steps of:
providing a plurality of electrical contacts each having a connecting section and a solder tail;
providing a base to secured the electrical contacts to form a contact module, the connect section and the solder tail extending out of the base;
providing an internal circuit board having a plurality of first golden fingers exposed at a front end thereof and a plurality of conductive traces corresponding to the first golden fingers, the first golden fingers and the conductive traces forming a plurality of electrical circuits;
connecting the connecting sections of the electrical contacts with the electrical circuits respectively;
providing an insulative housing surrounding a rear end of the internal circuit board and the contact module; and
providing a metal shell surrounding to the insulative housing and the internal circuit board to form a receiving space for accommodating a plug.

13. The method as claimed in claim 12, wherein an insulative housing is provided with a rear portion and a front portion protruding from the rear portion thereby forms a stopping face on the rear portion.

14. The method as claimed in claim 12, wherein the first golden fingers and the conductive traces are arranged on top and bottom surfaces of the internal circuit board, and wherein the electrical contacts include two groups of electrical contacts for connecting with the electrical circuits of the top and bottom surfaces respectively.

15. The method as claimed in claim 14, wherein the internal circuit board has a plurality of second golden fingers at a rear end thereof and connecting with the conductive traces, and wherein the connecting section of the electrical contacts are electrically connected with the second golden fingers.

16. The method as claimed in claim 14, wherein the internal circuit board has a plurality of soldering holes at a rear end thereof and connecting with the conductive traces, and wherein the connecting section of the electrical contacts are electrically connected with the soldering holes.

17. The method as claimed in claim 15, wherein the internal circuit board has a top layer, a bottom layer, and a middle layer, and wherein the first and second golden fingers and the conductive traces are disposed on the top and bottom layers.

18. The method as claimed in claim 17, wherein the electrical circuits on the bottom layer or the top layer each include two grounding circuits at outermost sides and a plurality of signal circuits located therebetween, and wherein the signal circuits on each layer includes two pair of high frequency signal circuits adjacent to the grounding circuits respectively, two power circuits at inner side of the high frequency signal circuits and four low frequency signal circuits located between the two power circuits, and wherein the electrical circuits on the top layer and the bottom layer are similar but disposed in opposite directions.

19. The method as claimed in claim 18, wherein the middle layer has two grounding copper foils at opposite sides thereof and a middle copper foil located between the grounding copper foils; and wherein the grounding circuits of the top and bottom layers contact with plated-through holes defined on the grounding copper foils to establish a grounding path; and wherein the power circuits of the top and bottom layers electrically connect with each other by the middle copper foil.

20. The method as claimed in claim 19, wherein the grounding copper foils extend into a pair of notches defined on opposite sides of the internal circuit boards for contacting with grounding tabs of the plug.
